(19) United States
(12) Patent Application Publication
(10) Pub. No.: US 2018/0032938 A1
(43) Pub. Date: Feb. 1, 2018

(54) DIAGNOSTIC ENGINE AND CLASSIFIER FOR DISCOVERY OF BEHAVIORAL AND OTHER CLUSTERS RELATING TO ENTITY RELATIONSHIPS TO ENHANCE DERANDOMIZED ENTITY BEHAVIOR IDENTIFICATION AND CLASSIFICATION

(71) Applicant: The Dun & Bradstreet Corporation, Short Hills, NJ (US)

(72) Inventors: Anthony J. Scriffignano, West Caldwell, NJ (US); Kobi Abayomi, Vailsburg, NJ (US)

(21) Appl. No.: 15/662,955

(22) Filed: Jul. 28, 2017

Related U.S. Application Data
(60) Provisional application No. 62/368,457, filed on Jul. 29, 2016.

(51) Int. Cl. G06Q 10/06; G06K 9/62

(52) U.S. Cl. CPC G06Q 10/06375; G06K 9/6277; G06Q 10/0635; G06N 3/008

(57) ABSTRACT

Embodiments of a system and methods therefor including an optimized classifier builder and diagnostic engine that derandomizes event data for atypical yet coordinated behavior of actors that appears random to conventional predictors. The system is configured to diagnose and build Artificial Intelligence and machine learning classifiers that identify, differentiate and predict behaviors for entities and groups of entities that can be masked by conventional predictive classification.

### CROSS REFERENCE TO RELATED APPLICATIONS

The present application claims priority to U.S. Provisional Patent Application No. 62/368,457, filed on Jul. 29, 2016, the entirety of which is incorporated by reference hereby.

### TECHNICAL FIELD

Disclosed are embodiments directed to Artificial Intelligence machine learning and analysis of interaction events among business entities.

### BACKGROUND

Data driven entity analysis involves the acquisition of datasets and databases of entity activities that correlate or are associated with the characteristics of an entity (e.g., size, propensity to fail, accounts, firmographics), but also on the relationship among entities interacting in a system or network (e.g. interacting with, competing with, mentioning). Recent focus on entity relationships has been placed not only on understanding the interaction of a group of entities, but on understanding particular sub-groups that may be acting intentionally or unintentionally in a coordinated way. Examples of this type of sub-group behavior include many benign observations (e.g., how millennials interact in digital advertising vs. how the population as a whole interacts), but increasingly focus on malfeasant behavior.

Examples of malfeasant behavior include traditional types of fraud, such as a ring of entities operating in concert to simulate the effects of large volumes of positive business experience in order to establish credit ratings to be used for future fraudulent activity, resulting in non-payment or non-performance. Another example of sub-group malfeasant behavior is a bustout, where one entity assumes operational control of another entity and forces it to behave in a way that is beneficial to the controlling party and detrimental (often to the point of business failure) to the subordinate entity.

Conventional systems analyze interacting groups of entities by establishing algorithms that classify the behavior of the large group. Based on the classification, individual event observations can be compared to the observations of the entire group and attributed a degree of deviation from the expected behavior. Conventional machine intelligence or analytics are based on linear models, and the underlying equations for the classification algorithms are typically first or multi-order linear equations.

In linear and generalized linear model classifiers, low degrees of heteroscedasticity support a strong assumption of constant and independent variation in model error with respect to the predictors. In other words, attributes that cause observations to deviate from the model are presumed to be random for stable estimation and classifier generation.

In conventional business analysis and alerting systems, to predict one behavior from a set of observations, measurements that describe coordinated atypical behavior with respect to the classifier model will violate the assumption of non-random error. The classifier model assumes at least partially non-heteroscedastic, or coordinated behavior and thus stable estimators of effect. Evidence to the contrary in a model to predict behavior is a signal of non-random behavior in the attributes considered by the model.

Conventional systems and analysis thus fail to identify behaviors that benefit from the heteroscedastic classification models they employ. For example, consider a population on which a system employing a conventional ‘predictor-response’ type classifier model has been established. Assume this population is made up of mostly ‘good’ actors—members who behave typically with respect to the model and a small cadre of ‘bad’ actors—members who behave atypically with respect to the model in a coordinated way. These bad actors will be hard or impossible to detect with conventional systems or data analysis, especially when the relative size of their population is low. In conventional classifier model based system diagnostics—which characterize overdispersion with respect to the model (model error) versus dispersion/instantiation of the predictors (predictor distance)—these observations can be mistaken for random outliers. The bad actors are able to hide behind a wrongful assumption that they are behaving randomly. Moreover, the larger the population of entities, the more cover for malfeasant or organized other non-random behaviors to evade detection.

Typical methods of clustering the model attributes (predictors) do not capture the relationship on the model outcome (response variable). Accordingly, conventional systems are configured to detect and alert users to, for example, fraud or other malfeasance that is masked by conventional data analysis. Similarly, conventional systems configured to identify activity and behavior that appear random, but in reality are not, fail to alert users to opportunities or risks that are present in a timely fashion. Further, conventional systems configured with linear models for large scale or big data analysis of behavior event data for a large population of entities, for example, business entity analysis or Customer Relationship Management systems, are unable to detect pockets of activity that is not random but appears so because of the model error, as the masking effect is proportional to the population and event data. Further, because such systems fail to identify and capture masked and non-random activity, conventional predictive systems not only fail to identify such activity; they fail to capture and improve understanding of changes and trends in such behaviors.

### SUMMARY

In at least one embodiment, described is a system for building behavior prediction classifiers for a machine learning application comprising:

a memory for storing at least instructions;

a processor device that is operative to execute program instructions;

a database of entity behavior events;

a prediction classifier building component comprising a predictor rule for analyzing each of a plurality inputted set of behavior events from the database of entity events and outputting a prediction classifier and a classification of each of the set of events, wherein an error for the prediction classifier is defined as random over the classification;

a diagnostic engine comprising:
an input configured to receive a permutation of the error for the at least one prediction rule and the set of classified events;
a diagnostic module configured to:
   derandomize the prediction classifier; and
   separate and label the irregular groupings from the derandomized events to form a diagnostic database or data package, and
an output the diagnostic database or data package to an optimized classifier building component;

an optimized classifier builder component comprising one or more predictor rules for classifying derandomized relationship events and outputting an optimized predictive classifier; and

a prediction engine including a classifier configured to produce automated entity behavior predictions including classifications of derandomized behaviors.

In at least one embodiment, the diagnostic engine module can be configured to derandomize the prediction classifier by at least:

applying the permutation of the error to each of the classified set of events,

calculating the smoothness of the permuted set of events, and

applying a maximizer to the smoothed events to reveal irregular groupings of events in the smoothed data; and

separate and label the irregular groupings from the smoothed events to form the diagnostic database or data package.

In at least one embodiment, the diagnostic engine module can be configured to derandomize the prediction classifier by at least calculating and smoothing each of the events in parallel.

In at least one embodiment, the permutation can be a covariate of the error for the at least one prediction rule configured to define an overdispersion of the classified set of vents.

In at least one embodiment, described is a method for building behavior prediction classifiers for a machine learning application comprising:

accepting an input of a set of behavior events from a database of entity behavior events into a prediction classifier building component;

outputting a prediction classifier and a classification of each of the set of events to a diagnostic engine, wherein an error for the prediction classifier is defined as random over the classification;

receiving a permutation of the error for the at least one prediction rule and the set of classified events into the diagnostic engine;

executing a diagnostic module of the diagnostic engine to at least:
derandomize the prediction classifier; and
separate and label the irregular groupings from the derandomized events to form a diagnostic database or data package, and

outputting the diagnostic database or data package to an optimized classifier building component; and

classifying derandomized relationship events and outputting an optimized predictive classifier from the optimized classifier builder component.

In at least one embodiment, the derandomizing of the prediction classifier can comprise:

applying the permutation of the error to each of the classified set of events, calculating the smoothness of the permuted set of events, and

applying a maximizer to the smoothed events to reveal irregular groupings of events in the smoothed data; and

separating and labeling the irregular groupings from the smoothed events to form the diagnostic database or data package.

In at least one embodiment, the method can include derandomizing the prediction classifier by at least: calculating and smoothing each of the events in parallel with the diagnostic engine module.

In at least one embodiment, the permutation can be a covariate or correlative of the error for the at least one prediction rule configured to define an overdispersion of the classified set of events.

In at least one embodiment, a computer program product can be encoded to, when executed by one or more computer processors, carry out the methods described herein.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A illustrates a logical architecture and environment for a system in accordance with at least one embodiment according to the present disclosure;

FIG. 1B an embodiment of a network computer that may be included in a system such as that shown in FIG. 2;

FIG. 2 is a system diagram of an environment in which at least one of the various embodiments may be implemented;

FIG. 3 illustrates a logical architecture of a conventional system and operation flowchart in accordance with at least one of the various embodiments;

FIG. 4 illustrates a logical architecture of a system and operation flowchart in accordance with at least one of the various embodiments;

FIGS. 5A-5C illustrates examples of predictor vectors that are modeled to fit event distributions;

FIG. 6 illustrates a flowchart for diagnostic operations in accordance with at least one of the various embodiments;

FIGS. 7A-7D are illustrative graphs visualizing data event processing for a system including the diagnostic engine; and

FIG. 8 is a block diagram wherein the results of conventional credit decisioning data is further processed via the diagnostic engine and classifier.

### DETAILED DESCRIPTION OF THE EMBODIMENTS

Various embodiments now will be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may take the form of a hardware embodiment, a software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used in this application, the terms “component,” “module” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the detailed description describes various embodiments of the present invention for illustration purposes and embodiments include the methods described and may be implemented using one or more apparatus, such as processing apparatus coupled to electronic media. Embodiments may be stored on an electronic media (electronic memory, RAM, ROM, EEPROM) or programmed as computer code (e.g., source code, object code or any suitable programming language) to be executed by one or more processors operating in conjunction with one or more electronic storage media.

Various embodiments are directed to an analysis of interaction among business entities, although any entity analysis is embraced by the present disclosure. Entity analysis is increasingly focusing not only on the attributes of a particular entity (e.g. size, propensity to fail, firmographics), but also on the relationship among entities interacting in a system. The ability to understand these interactions has been studied in the past in many ways, for example in competition theory, game theory, macroeconomics, and behavioral economics. Additional work has been done to understand entity interaction by using physical and natural metaphors, for example using behavioral observations of swarms and flocks in the animal kingdom to understand the flow of people in crowds. As will be appreciated, “event” and “behavior event” as used in herein broadly includes data for entity analysis and entity relationship analysis, including any dyadic relationship between entities.

As described herein, entity relationships can be analyzed in terms of interaction events for a group of entities as well as processing interaction event data to obtain data on particular sub-groups that may be acting intentionally or unintentionally in a coordinated way. Examples of this type of sub-group behavior include many benign observations (e.g. how millennials interact in digital advertising vs. how the population as a whole interacts), but also can focus on malfeasant behavior.

Examples of malfeasant behavior include traditional types of fraud, such as a ring of entities operating in concert to simulate the effects of large volumes of positive business experience in order to establish credit ratings to be used for future fraudulent activity resulting in non-payment or non-performance. Another example of sub-group malfeasant behavior is a bustout, where one entity assumes operational control of another entity and forces it to behave in a way that is beneficial to the controlling party and detrimental (often to the point of business failure) to the subordinate entity.

Data relating to entity relationships (relationships among multiple parties interacting in some complex way) is traditionally observed using statistical relationships, including dyadic relationships and interactions. One of these relationships relates to the degree to which observations of entity behaviors distribute with respect to one another. One measure of such distribution is heteroscedasticity. The conventional way of looking at groups of entities interacting is to establish some sort of model or data processing prediction rule that describes the behavior of the large group. Having established a probability rule relationship, individual observations, or behavior events, can be compared to the observations of the entire group and attributed a degree of deviation from the expected behavior. These models are often generalized linear models (because the underlying equations are typically first or multi-order linear equations).

In linear (and generalized linear models) low heteroscedasticity supports the strong assumption of constant and independent variation in model error with respect to the predictors. In other words, attributes that cause observations to deviate from the model are presumed to be random. This presumption is necessary for stable estimation.

Consider, for example, a process for predicting one behavior from a set of observations (set of entity behavior events). Measurements that describe coordinated atypical behavior with respect to the model will violate the assumption of non-random error. A model assumes non-heteroscedastic, or coordinated, behavior and thus stable estimators of effect. Evidence to the contrary in a model to predict behavior is a signal of non-random behavior in the attributes considered by the model.

Now consider a population on which a “predictor-response” type model has been established. Assume this population is made up of mostly ‘good’ actors—members who behave typically with respect to the model a small cadre of ‘bad’ actors—members who behave atypically with respect to the model in a coordinated way. Often these bad actors will be hard to detect, especially when the relative size of their population is low. In typical model based diagnostics—which generally characterize overdispersion with respect to the model (model error) versus dispersion/instantiation of the predictors (predictor distance)—these observations, the entity behavior events, may be mistaken for random outliers. The bad actors hide behind a wrongful assumption that they are behaving randomly.

Conventional methods of clustering the model attributes (predictors) do not capture the relationship on the model outcome (response variable). The ability to look at a large corpus of data with respect to relationships among the entities and to discern pockets of interesting behavior can be powerful, especially in a big data context where the amount of “uninteresting” data can easily overwhelm the ability to find the behaviors of interest.

As will be appreciated, although exemplary linear and statistical models are described herein, the term “model” and “classifier model” as used herein broadly includes other methods and modeling for correlation, covariance, pattern recognition, clustering, and grouping for heteroscedastic analysis as described herein, including methods such as neuromorphic models (e.g. for neuromorphic computing and engineering), non-parametric methods, and non-regressive models or methods.

In at least one of the various embodiments, described is a system including a diagnostic engine that exploits the modeling assumptions (e.g., between the predictors and responses, among the predictors, and between the predicted and observed values) using model based diagnostics as criteria for population discovery. Described are embodiments of a system and methods therefor configured to permute covariates/observations as inputs to diagnostics describing lack of fit/overdispersion, calculate the smoothness or regularity of these diagnostics with respect to these permutations, and maximize irregularity in the diagnostic smoothness to separate and classify covariates/observations with atypical behavior. As will be appreciated, smoothness as used herein refers to any diagnostic techniques that smooth with respect to fit and goodness to fit.

### Illustrative Logical System Architecture and Environment

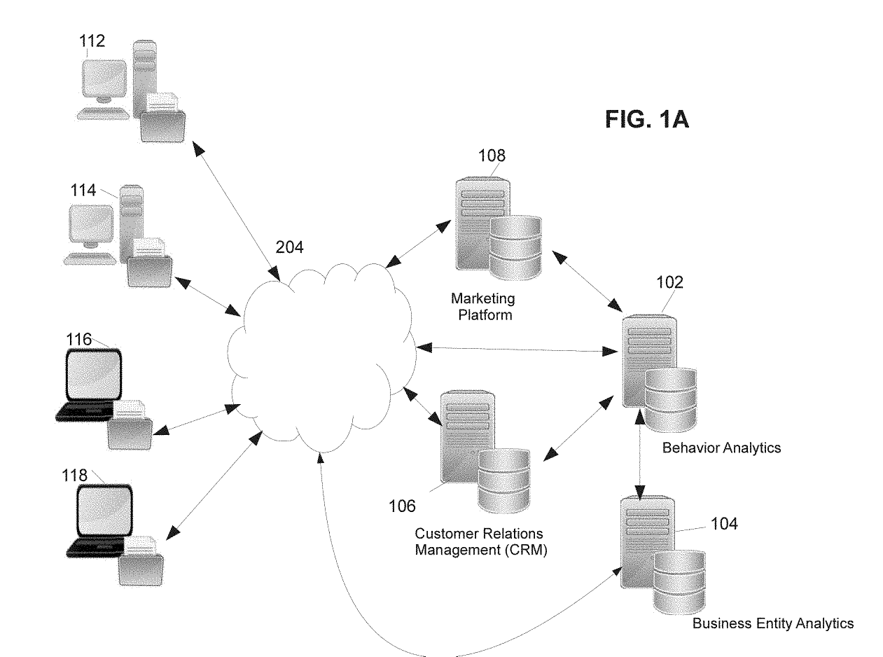

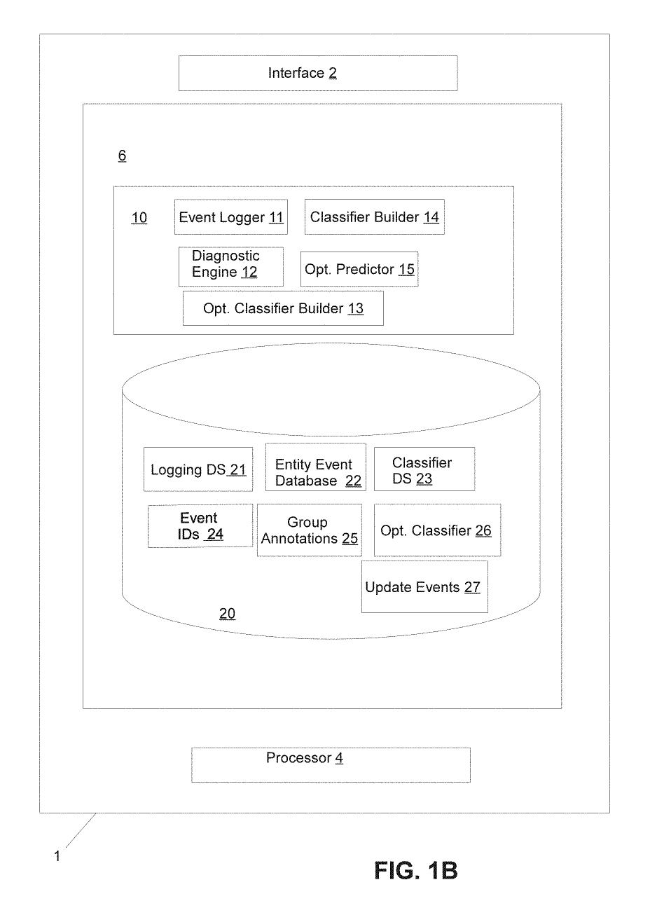

FIG. 1A illustrates a logical architecture and environment for a system 100 in accordance with at least one of the various embodiments. In at least one of the various embodiments, Behavior Analytics Server 102 can be arranged to be in communication with Business Entity Analytics Server 104, Customer Relation Management Server 106, Marketing Platform Server 108, or the like. As will be appreciated, CRM platforms or marketing platforms are illustrative examples of platforms that can make use of behavior event analytics as described herein, and many other platforms can be provided with them, such as social network platforms, credit service platforms, gambling platforms, financial services, and so on.

In at least one of the various embodiments, Behavior Analytics Server 102 can be one or more computers arranged for predictive analytics as described herein. In at least one of the various embodiments, Behavior Analytics Server 102 can include one or more computers, such as, network computer 1 of FIG. 1B, or the like.

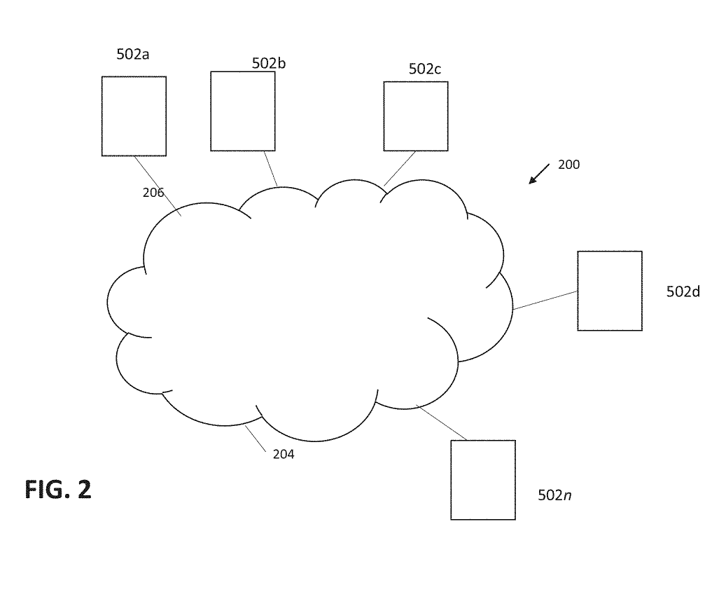

In at least one of the various embodiments, Business Entity Analytics Server 104 can be one or more computers arranged to provide business entity analytics, such as, network computer 1 of FIG. 1B, or the like. As described herein, Business Entity Analytics Server 104 can include a database of robust company/business entity data and/or account data to provide and/or enrich event databases 22 as described herein. Examples of Business Entity Analytics Servers 104 are described in U.S. Pat. No. 7,822,757, filed on Feb. 18, 2003 entitled System and Method for Providing Enhanced Information, and U.S. Pat. No. 8,346,790, filed on Sep. 28, 2010 and entitled Data Integration Method and System, the entirety of each of which is incorporated by reference herein. The Business Entity Analytics Platform 208 can provide or be integrated with other platforms to provide, for instance, a business credit report, comprising ratings (e.g., grades, scores, comparative/superlative descriptors) based on one or more predictor models. In at least one of the various embodiments, Business Entity Analytics Servers 104 can include one or more computers, such as, network computer 1 of FIG. 2, or the like.

In at least one of the various embodiments, CRM Servers 106, can include one or more third-party and/or external CRM services that host or offer services for one or more types of customer databases that are provided to and from client users. For example, CRM servers 106 can include one or more web or hosting servers providing software and systems for customer contact information like names, addresses, and phone numbers, and tracking customer event activity like website visits, phone calls, sales, email, texts, mobile, and the like. In at least one of the various embodiments, CRM servers can be arranged to integrate with Behavior Analytics Server 102 using API's or other communication interfaces. For example, a CRM service can offer a HTTP/REST based interface that enables Behavior Analytics Server 102 to accept event databases 22 which include behavior events that can be processed by the Behavior Analytics Server 102 and the Business Entity Analytics Server 104 as described herein.

In at least one of the various embodiments, Marketing Platform Servers 108, can include one or more third-party and/or external marketing service Marketing Platform Servers 108 can include, for example, one or more web or hosting servers providing marketing distribution platforms for marketing departments and organizations to more effectively market on multiple channels such as, for example, email, social media, websites, phone, mail, etc.) as well as automate repetitive tasks for, or the like. In at least one of the various embodiments, Behavior Analytics Server 102 can be arranged to integrate and/or communicate with Marketing Platform 108 using API's or other communication interfaces provided by the services. For example, a Marketing Automation Platform Servers can offer a HTTP/REST based interface that enables Behavior Analytics Server 102 to output diagnostic data and behavior predictions processed by the Prospect Analytics Server 102 and the Business Entity Analytics Server 104 as described herein.

In at least one of the various embodiments, files and/or interfaces served from and/or hosted on Behavior Analytics Servers, Business Entity Analytics Servers 104, CRM 406 Servers, and Marketing Automation Platform Servers 108 can be provided over network 204 to one or more client computers, such as, Client Computer 112, Client Computer 114, Client Computer 116, Client Computer 118, or the like.

Behavior Analytics Server 102 can be arranged to communicate directly or indirectly over network 204 to the client computers. This communication can include providing diagnostic outputs and prediction data based on behavior events provided by client users on client computers 112, 114, 116, 118. For example, the Behavior Analytics Server can obtain behavior event databases from client computers 112, 114, 116, 118 for AI machine learning training and classifier production as described herein. After processing, the Behavior Analytics Server 102 can communicate with client computers 112, 114, 116, 118 and output diagnostic data and prediction data as described herein.

In at least one of the various embodiments, Behavior Analytics Server 102 can employ the communications to and from CRM Servers 106 and Marketing Automation Platform Servers 108 or the like, to accept event databases from or on behalf of clients and output diagnostic data and prospect predictions based on behavior event databases. For example, a CRM can obtain or generate company event databases from client computers 112, 114, 116, 118, which are communicated to the Behavior Analytics Server 102 for AI machine learning training and classifier production as described herein. After processing, the Behavior Analytics Server 102 can communicate with CRM servers 106 and/or Marketing Automation Platform Servers and output company event behavior data and prediction data as described herein. In at least one of the various embodiments, Behavior Analytics Server 102 can be arranged to integrate and/or communicate with CRM server 106 or Marketing Platform Servers 108 using API's or other communication interfaces. Accordingly, references to communications and interfaces with client users herein include communications with CRM Servers, Marketing Automation Platform Servers, or other platforms hosting and/or managing communications and services for client users.

One of ordinary skill in the art will appreciate that the architecture of system 100 is a non-limiting example that is illustrative of at least a portion of at least one of the various embodiments. As such, more or less components can be employed and/or arranged differently without departing from the scope of the innovations described herein. However, system 100 is sufficient for disclosing at least the innovations claimed herein.

### Illustrative Computer

FIG. 1B shows an embodiment of a system overview for a system for entity behavior analysis and prediction including a diagnostic engine configured to identify and mark group behavior masked as random behaviors. In at least one of the various embodiments, system 1 comprises a network computer including a signal input/output, such as via a network interface 2, for receiving input such as an audio input, a processor 4, and memory 6, including program memory 10, all in communication with each other via a bus. In some embodiments, processor may include one or more central processing units. As illustrated in FIG. 1B, network computer 1 also can communicate with the Internet, or some other communications network, via network interface unit 2, which is constructed for use with various communication protocols including the TCP/IP protocol. Network interface unit 2 is sometimes known as a transceiver, transceiving device, or network interface card (NIC). Network computer 1 also comprises input/output interface for communicating with external devices, such as a keyboard, or other input or output devices not shown. Input/output interface can utilize one or more communication technologies, such as USB, infrared, Bluetooth™, or the like.

Memory 6 generally includes RAM, ROM and one or more permanent mass storage devices, such as hard disk drive, tape drive, optical drive, and/or floppy disk drive. Memory 6 stores operating system for controlling the operation of network computer 1. Any general-purpose operating system may be employed. Basic input/output system (BIOS) is also provided for controlling the low-level operation of network computer 1. Memory 6 may include processor readable storage media 10. Processor readable storage media 10 may be referred to and/or include computer readable media, computer readable storage media, and/or processor readable storage device. Processor readable storage media 10 may include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computer.

Memory 6 further includes one or more data storage 20, which can be utilized by network computer to store, among other things, applications and/or other data. For example, data storage 20 may also be employed to store information that describes various capabilities of network computer 1. The information may then be provided to another computer based on any of a variety of events, including being sent as part of a header during a communication, sent upon request, or the like. Data storage 20 may also be employed to store messages, web page content, or the like. At least a portion of the information may also be stored on another component of network computer, including, but not limited to processor readable storage media, hard disk drive, or other computer readable storage medias (not shown) within computer 1.

Data storage 20 can include a database, text, spreadsheet, folder, file, or the like, that can be configured to maintain and store user account identifiers, user profiles, email addresses, IM addresses, and/or other network addresses; or the like.

In at least one of the various embodiments, Data storage 20 can include databases, which can contain information determined from one or more events for one or more entities.

Data storage 20 can further include program code, data, algorithms, and the like, for use by a processor, such as processor 4 to execute and perform actions. In one embodiment, at least some of data store 20 might also be stored on another component of network computer 1, including, but not limited to processor-readable storage media, hard disk drive, or the like.

The system 1 includes a diagnostic engine 12. The system also includes data storage memory 20 including a number of data stores 21, 22, 23, 24, 25, 26, 27 which can be hosted in the same computer or hosted in a distributed network architecture. The system 1 includes a data store for a set of entity behavior events 22. The system 1 further includes a classifier component including a classifier data store 23 comprising a set of primary prediction classifiers (e.g., an initial set of classifiers), as well as a primary prediction classifier model building program 14 for, when executed by the processor, mapping the set of entity event behaviors either previously stored or processed by an event logger 11 and stored in a database of entity behavior events 22 to the initial set of classifiers.

The system includes a data store for storing behavior event identifications 24 and a data store for storing group annotations 25. Such data can be stored, for example, on one or more SQL servers (e.g., a server for the group annotation data and a server for the behavior event identification data).

The system can also include a logging component including logging program 11 for, when executed by a processor, logging and storing data associated with the entity behavior events. A logging data store 21 can store instances of entity behavior events identified by the event logger 11 at the initial classifiers together with logging data for optimized classifiers. Instances of entity behavior events at these classifiers can be stored together with logging data including the name and version of the classifier(s) active, the behavior classification for the entity, the time of the behavior event, the prediction module's hypothesis of the behavior event, the event data itself, the system's version and additional information about the system, the entity, and the event features.

The logging data store 21 can include data reporting predictions for entities when the events were recorded and the events themselves. The prediction model, event scores, and the group classes of the prediction models can also be stored. Thus, logging data can include data such as the classification status of an entity behavior event, the prediction model employed, and model errors.

The system 1 further includes an optimized prediction classifier model building component 14 including an optimized classifier data store 26 comprising a set of optimized prediction classifiers, as well as an optimized prediction classifier model building program 14 for, when executed by the processor, mapping the set of entity event behaviors processed by the diagnostic engine 12 and stored in a diagnostic database of updated entity behavior events 27 to the optimized set of classifiers.

The system 1 includes an optimized prediction module 15. The optimized prediction module 15 can include a program or algorithm for, when executed by the processor, automatically predicting entity behavior events from objective measures, i.e. observations and entity transactions logged as entity behavior events stored in the logging data store 21 and the entity behavior data store 22. Artificial Intelligence (AI) machine learning and processing, including AI machine learning classification can be based on any of a number of known machine learning algorithms, including classifiers such as the classifiers described herein (e.g., decision tree, propositional rule learner, linear regression, etc.).

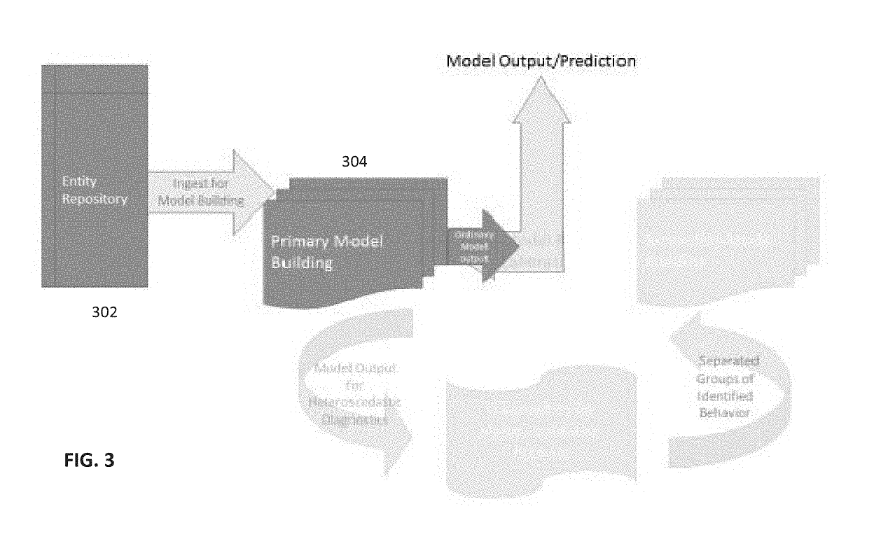

Event logger 11, primary prediction classifier model building program 14, diagnostic engine 12, optimized prediction classifier model building component 13, and optimized prediction module 15 can be arranged and configured to employ processes, or parts of processes, similar to those described in conjunction with FIGS. 3-6, to perform at least some of its actions.

Although FIG. 1B illustrates the system 1 as a single network computer, the invention is not so limited. For example, one or more functions of the network server computer 1 may be distributed across one or more distinct network computers. Moreover, the system 1 network server computer is not limited to a particular configuration. Thus, in one embodiment, network server computer may contain a plurality of network computers. In another embodiment, network server computer may contain a plurality of network computers that operate using a master/slave approach, where one of the plurality of network computers of network server computer is operative to manage and/or otherwise coordinate operations of the other network computers. In other embodiments, the network server computer may operate as a plurality of network computers arranged in a cluster architecture, a peer-to-peer architecture, and/or even within a cloud architecture. The system may be implemented on a general-purpose computer under the control of a software program and configured to include the technical innovations as described herein. Alternatively, the system 1 can be implemented on a network of general-purpose computers and including separate system components, each under the control of a separate software program, or on a system of interconnected parallel processors, the system 1 being configured to include the technical innovations as described herein. Thus, the invention is not to be construed as being limited to a single environment, and other configurations, and architectures are also envisaged.

### Illustrative Operating Environment

FIG. 2 shows components of one embodiment of an environment in which embodiments of the innovations described herein may be practiced. Not all of the components may be required to practice the innovations, and variations in the arrangement and type of the components may be made without departing from the spirit or scope of the innovations.

FIG. 2 shows a network environment 200 adapted to support the present invention. The exemplary environment 200 includes a network 204, and a plurality of computers, or computer systems 202 (a) . . . (n) (where “n” is any suitable number). Computers could include, for example one or more SQL servers. Computers 202 can also include wired and wireless systems. Data storage, processing, data transfer, and program operation can occur by the inter-operation of the components of network environment 200. For example, a component including a program in server 202(a) can be adapted and arranged to respond to data stored in server 202(b) and data input from server 202(c). This response may occur as a result of preprogrammed instructions and can occur without intervention of an operator.

The network 204 is, for example, any combination of linked computers, or processing devices, adapted to access, transfer and/or process data. The network 204 may be private Internet Protocol (IP) networks, as well as public IP networks, such as the Internet that can utilize World Wide Web (www) browsing functionality, or a combination of private networks and public networks.

Network 204 is configured to couple network computers with other computers and/or computing devices, through a wireless network. Network 204 is enabled to employ any form of computer readable media for communicating information from one electronic device to another. Also, network 204 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 204 may be configured to transport information of an Internet Protocol (IP). In essence, network 204 includes any communication method by which information may travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

The computers 202 may be operatively connected to a network, via bi-directional communication channel, or interconnector, 206, which may be for example a serial bus such as IEEE 1394, or other wire or wireless transmission media. Examples of wireless transmission media include transmission between a modem (not shown), such as a cellular modem, utilizing a wireless communication protocol, or wireless service provider or a device utilizing a wireless application protocol and a wireless transceiver (not shown). The interconnector 204 may be used to feed, or provide data.

A wireless network may include any of a variety of wireless sub-networks that may further overlay stand-alone ad-hoc networks, and the like, to provide an infrastructure-oriented connection for computers 202. Such sub-networks may include mesh networks, Wireless LAN (WLAN) networks, cellular networks, and the like. In one embodiment, the system may include more than one wireless network. A wireless network may further include an autonomous system of terminals, gateways, routers, and the like connected by wireless radio links, and the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile devices, such as client computers, with various degrees of mobility. In one non-limiting example, wireless network may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, a wireless network may include virtually any wireless communication mechanism by which information may travel between a computer and another computer, network, and the like.

A computer 202(a) for the system can be adapted to access data, transmit data to, and receive data from, other computers 202 (b) . . . (n), via the network or network 204. The computers 202 typically utilize a network service provider, such as an Internet Service Provider (ISP) or Application Service Provider (ASP) (ISP and ASP are not shown) to access resources of the network 504.

The terms “operatively connected” and “operatively coupled”, as used herein, mean that the elements so connected or coupled are adapted to transmit and/or receive data, or otherwise communicate. The transmission, reception or communication is between the particular elements, and may or may not include other intermediary elements. This connection/coupling may or may not involve additional transmission media, or components, and may be within a single module or device or between one or more remote modules or devices.

For example, a computer hosting a diagnostic engine may communicate to a computer hosting one or more classifier programs and/or event databases via local area networks, wide area networks, direct electronic or optical cable connections, dial-up telephone connections, or a shared network connection including the Internet using wire and wireless based systems.

### Generalized Operation

The operation of certain aspects of the various embodiments will now be described with respect to FIGS. 3-7. In at least one of various embodiments, the system described in conjunction with FIGS. 3-6 may be implemented by and/or executed on a single network computer, such as network server computer 1 of FIG. 1. In other embodiments, these processes or portions of these processes may be implemented by and/or executed on a plurality of network computers, such as network computers 202 (a) . . . (n) of FIG. 2. However, embodiments are not so limited, and various combinations of network computers, client computers, virtual machines, or the like may be utilized. Further, in at least one of the various embodiments, the processes described in conjunction with FIGS. 3-4 and FIG. 6 can be operative in system with logical architectures such as those described in conjunction with these Figures.

FIGS. 3-4 and 6 illustrate a logical architecture of system and system flow for AI predictive analytics for entity behavior events and populations in accordance with at least one of the various embodiments. In at least one of the various embodiments, an entity relation database 402 may be arranged to be in communication with classifier servers 404, 408, diagnostic engine servers 406, prediction servers 410, or the like.

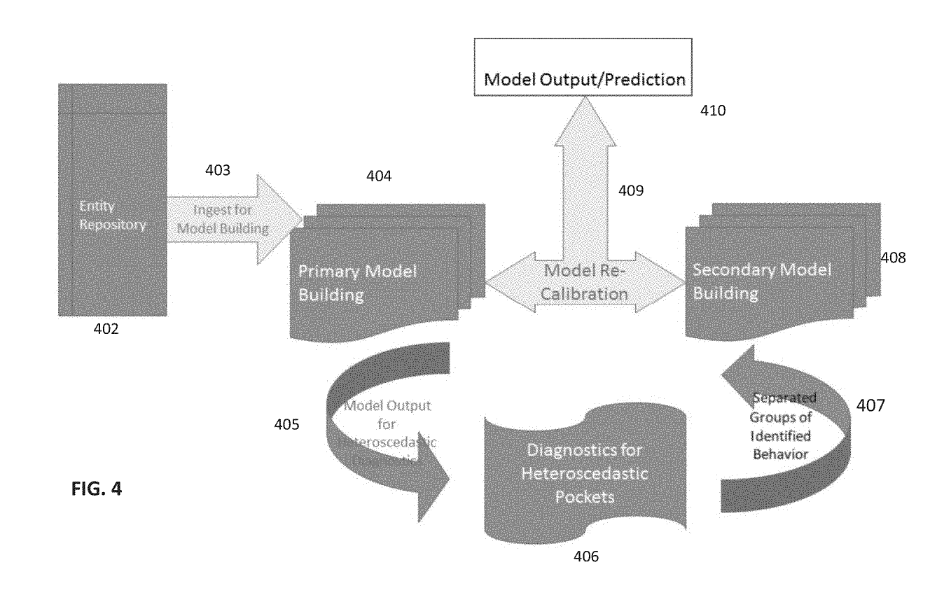

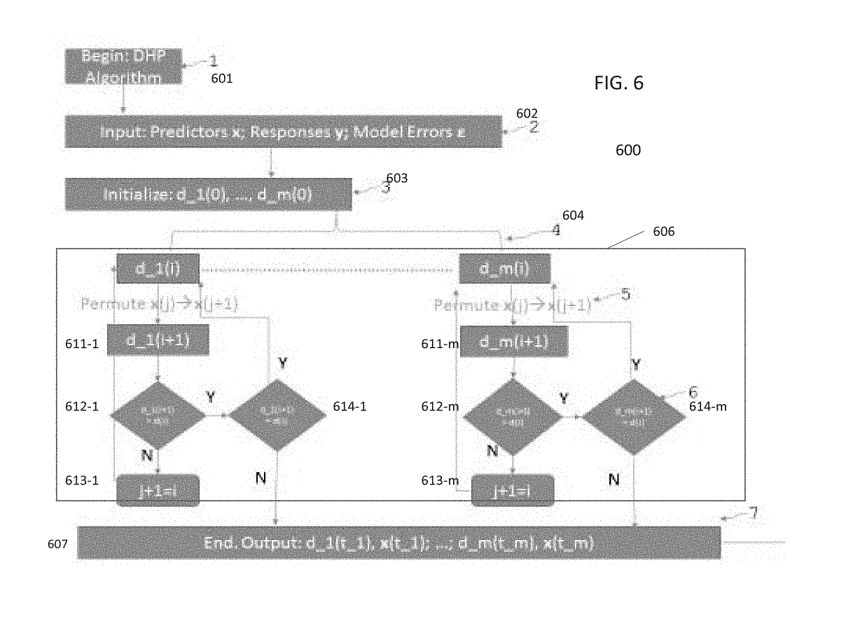

At operation 403, an entity database repository 402 of entity behavior events, is configured to output relationship behavior data for observation events (y) from the database 402 of predefined entities and entity events to prediction classifier model building component 404. The entity database repository 402 includes, for example, one or more databases of curated, increasing sets of data relating to counterparties in complex business relationships and the associated attributes which can be used to observe or impute dyadic or multiple counterparty associations among the entities. For purposes of understanding, simplified exemplary databases of events (e.g. trades/trade data, late payments) and entities (traders, businesses making payments) are described herein. Exemplary databases including behavior events can be provided, for example, from CRM servers, marketing platforms, and client computers. Databases can also be provided or enriched by Business Entity Analytics Server 104. Business Entity Analytics Server 104 The prediction classifier model building component 404 comprises a predictor module (x) for analyzing and classifying each of a plurality inputted set of relationship behavior events (y) ingested from the entity database repository 402. At operation 405, the prediction classifier model building component 404 is then configured to output the prediction classifier model including the classified set of events and the prediction classifier model to a diagnostic engine configured to perform diagnostics as described in more detail with respect to FIG. 6. The model error E for the prediction classifier model is defined as random over the model. In at least one embodiment, the AI system and process described in FIGS. 4 and 6 are configured to perform an explicit search for hidden abnormal behavior recalibrates and adjust the models and thus the predictions.

At operation 406 a diagnostic engine is configured to receive and analyze the prediction classifier model output to diagnose and identify non-random behavior groupings of events that are obscured by the model error (i.e. diagnostics for heteroscedasticity), as described herein in more detail with respect FIG. 6. The diagnostic engine is configured to perform diagnostics for heteroscedastic pockets (DHP) of entity behavior events. Both the data from the entity repository and the model based output on the data (predictions, selected covariates, error, etc.) are inputs to the DHP diagnostic engine. The DHP diagnostic engine looks for the maximal difference in diagnostic permutations of model processed entity behavior events for heteroscedasticity across groups of events. Groups are then annotated (labeled) under this maximization. Group identification (of suspicious behavior) and the model and the data are inputs to the secondary modeling procedure.

The diagnostic engine is configured to separate, sort and label the derandomized groupings to form a diagnostic database or diagnostic data package including data for the derandomized entity behavior groups. The diagnostic engine is configured search over the projection of model output onto diagnostics for heteroscedasticity as the projection where heteroscedasticity is most obvious can be employed to classify for abnormal behavior. In at least one embodiment the diagnostic engine can be configured to preform Bayesian operations as parameters for building the classifier, as classification can be updated over repeated data ingests. For example, the diagnostic engine performs iterative permutation of model predictors, iteratively calculates diagnostics over permuted groups, and then re-permutes the diagnostics to minimize the diagnostic value. The ‘onto’ space for these projections is the dimension of the model and the number of possible malfeasant groups.

The following examples are given to offer a high-level explanation of model measurements and diagnostic permutations for the system, followed by the technical implementation of an AI machine intelligence for performing the diagnostic operations and for AI classifier model building.

### EXAMPLE 1

For purposes of illustration, the following example employs a highly simplified univariate model. In the exemplary illustration a linear model includes one predictor and the response event is an entity behavior, for example a collection of trade experiences (entity behavior events) containing a fraud ring.

y=β₀+β₁X+ε

ε˜N(0, σ²)

In the example, there can be two populations for entity behaviors, one that is engaging in normal trade events and one engaging malfeasant behaviors (e.g. the fraud ring). The linear model assumes a low heteroscedasticity—meaning that the model error—is defined as random over the model for the predictor x, and thus the prediction.

ε˜N(0, σ²)

ε⊥χ

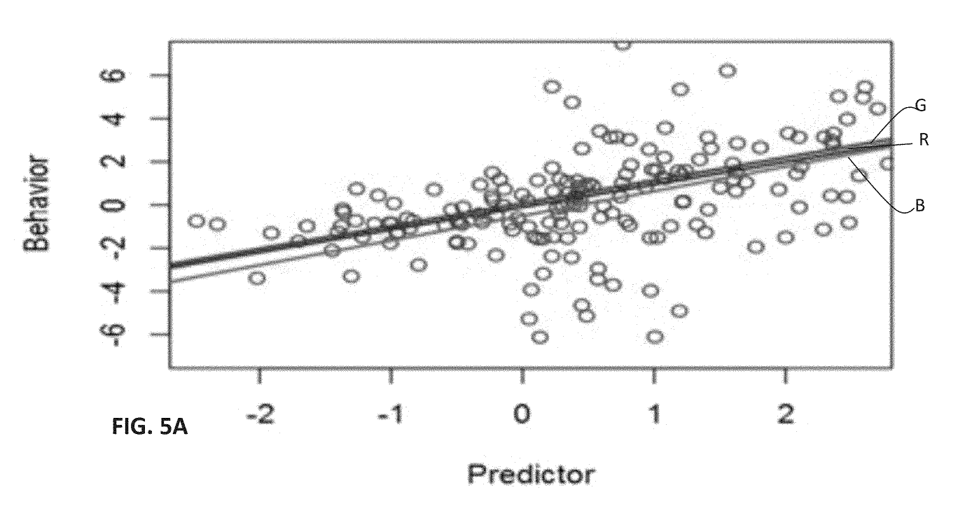

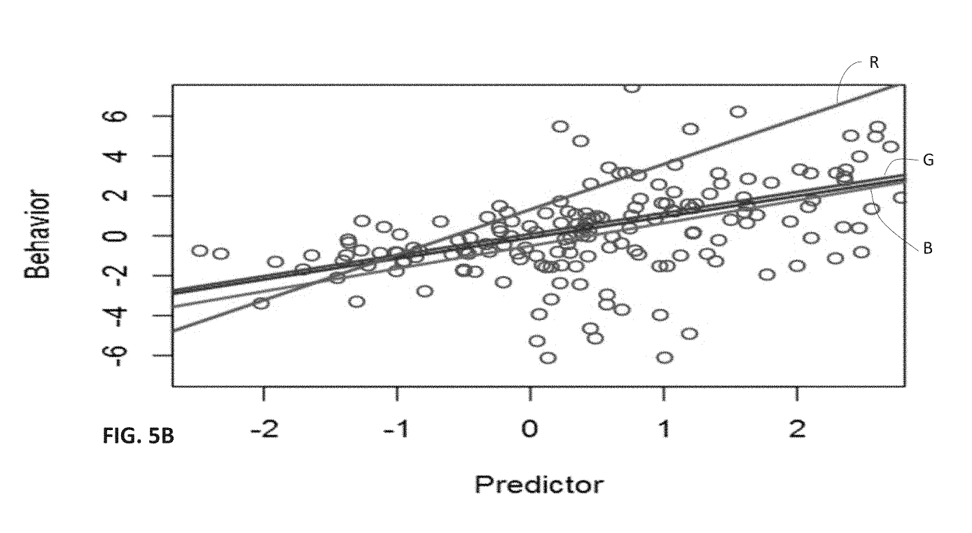

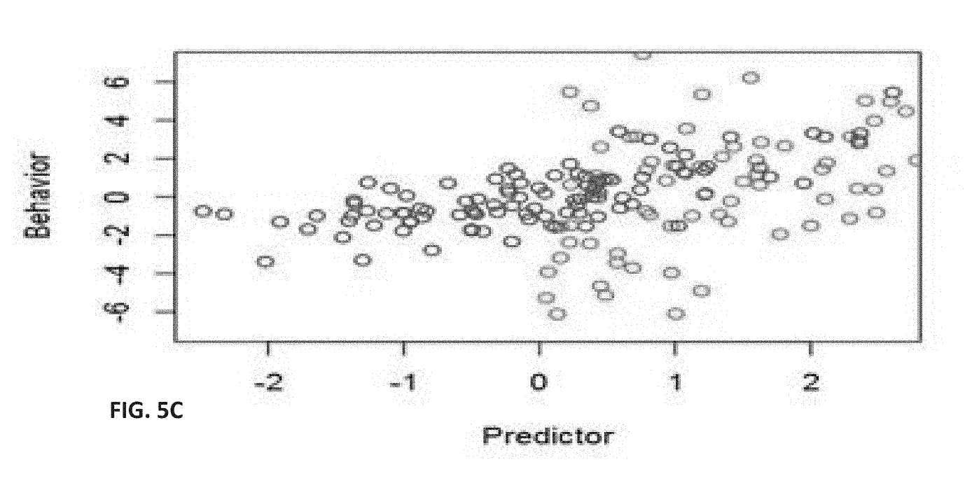

FIG. 5A illustrates an example of three predictor vectors G, R and B, where the lines G, R, B are the model m fit to the normal data G, all the data R, and just the bad actors B, where the model assumptions are correct, that is, the model error is assumed to be random over the model for the predictor. With respect to the model—the apparent effects of different groups of actors appear minimal. FIG. 5B illustration showing three predictor vectors G, R and B, where the model m fit to the normal data G, all the data R, and just the bad actors B is adjusted to meet a modeling assumption of homoscedasticity. FIG. 5C is an illustration of the entity behavior event plotting where the bad actors R, for example a fraud ring, are now able to be distinguished based on the adjustment for homoscedasticity, which reveals the pattern that was masked by the linear model and assuming outliers are random and, assuming outliers are random, would be randomly dispersed across the model. However, by appreciating that bad or irregular actors may act in accord with patterns that would be obscured by assuming the acts are random, adjusting for homoscedastic activity among such actors can derandomize and reveal the pattern of activity—for example a fraud ring acting in the larger population—for purposes of prediction and classification. As will be appreciated, post hoc it is clear that the populations differ—but such identification is nigh-impossible without the adjusted model fit as provided by embodiments as described herein.

### EXAMPLE 2

In at least one of the various embodiments, described is a system and methods therefor including a diagnostic engine that exploits the modeling assumptions (between the predictors and responses, among the predictors, and between the predicted and observed values) using model based diagnostics as criteria for population discovery. In at least one embodiment, described is a system and methods therefor configured to permute covariates/correlatives/observations as inputs to diagnostics describing lack of fit/overdispersion, calculate the smoothness or regularity of these diagnostics with respect to these permutations, and maximize irregularity in the diagnostic smoothness to separate and classify covariates/observations with atypical behavior.

For purposes of illustration, an exemplary yet simplified multivariate model illustrates an example of an application of adjusting the modeling assumptions to reveal and predict unusual or malicious behavior. For example, in the illustration, the adjustment can be employed to uncover an identity thief assuming the identity of several small businesses and acting in a malfeasant way while those same businesses continue to operate normally, unaware of the fraud.

yᵢ=βXᵢαεᵢ

### ε˜N(0, σ²I)

The assumptions affect the model estimators such that as the model estimators become overdispersed, the variance-covariance matrix of the model matrix—the matrix of predictors—decreases in rank. That is, when the predictors have atypical dependency properties.

ŷ=X(X^{T}X)⁻¹X^{T}Y

\hat{β}=X(X^{T}X)⁻¹X^{T}Y

Var (\hat{β})=σ²(X^{T}X)⁻¹

Var(X)∝X^{T}X

In the above equations, the variance-covariance matrix of the predictors is X^{T}X. This matrix is again seen to have a role in the model residuals: the differences between the predicted and observed values—with respect to the model. For illustration, now assume that there are “pockets” of malfeasant actors in groups i, j k, a vector of predictors which are Booleans for group membership, and a response variable for some ‘interesting’ behavior.

As shown below, the diagnostic engine is configured to cast a diagnostic as a statistic—in the present example a smooth curve fitted to the square root of model errors squared—under a permutation of the data events that minimize the smoothness of the curve—thereby yielding clear group separation within the overall population.

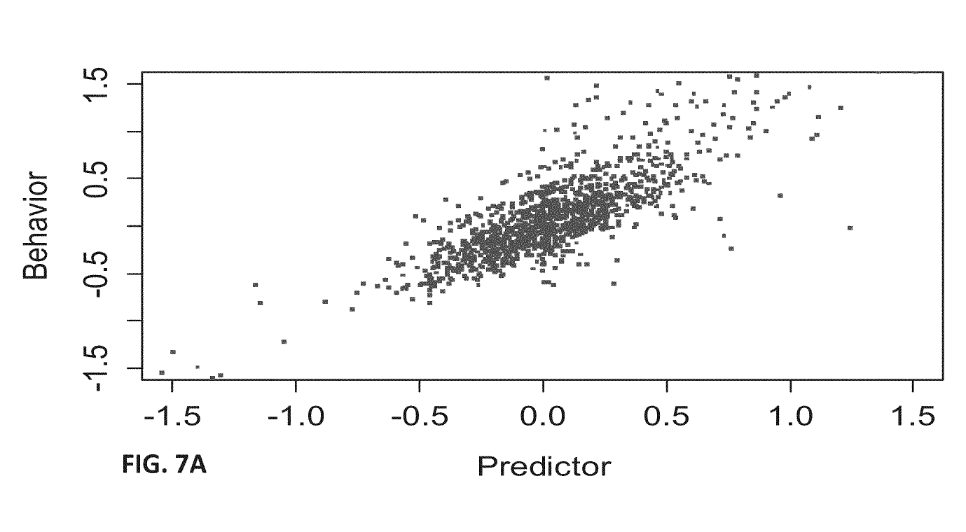

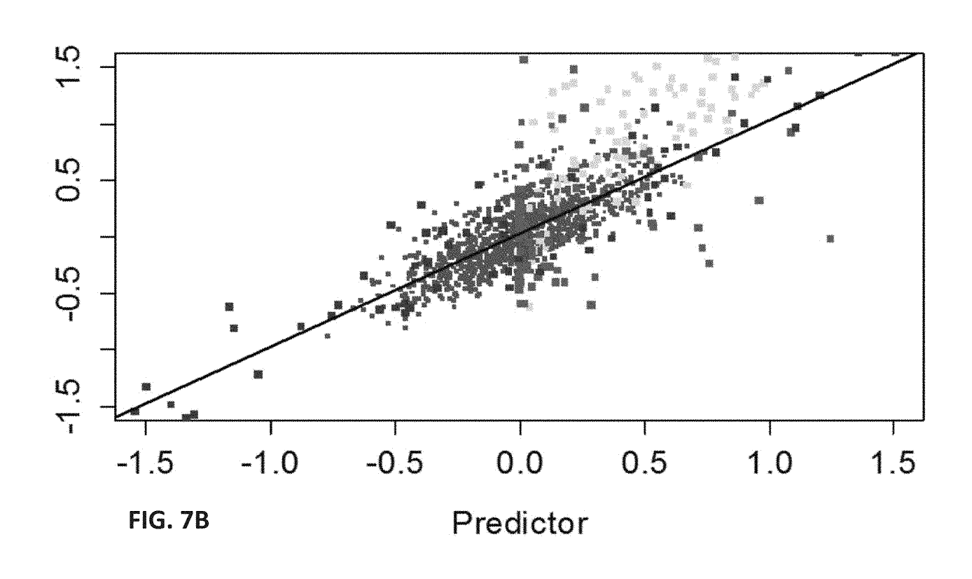

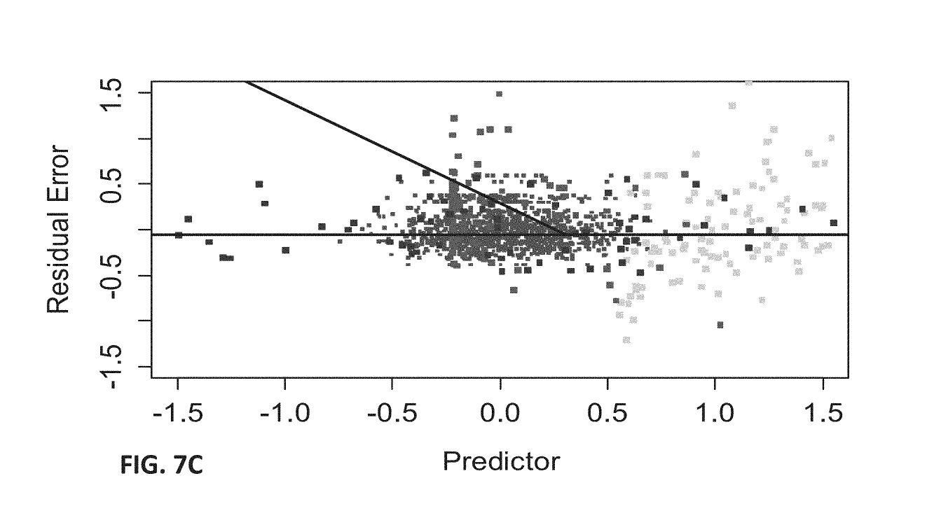

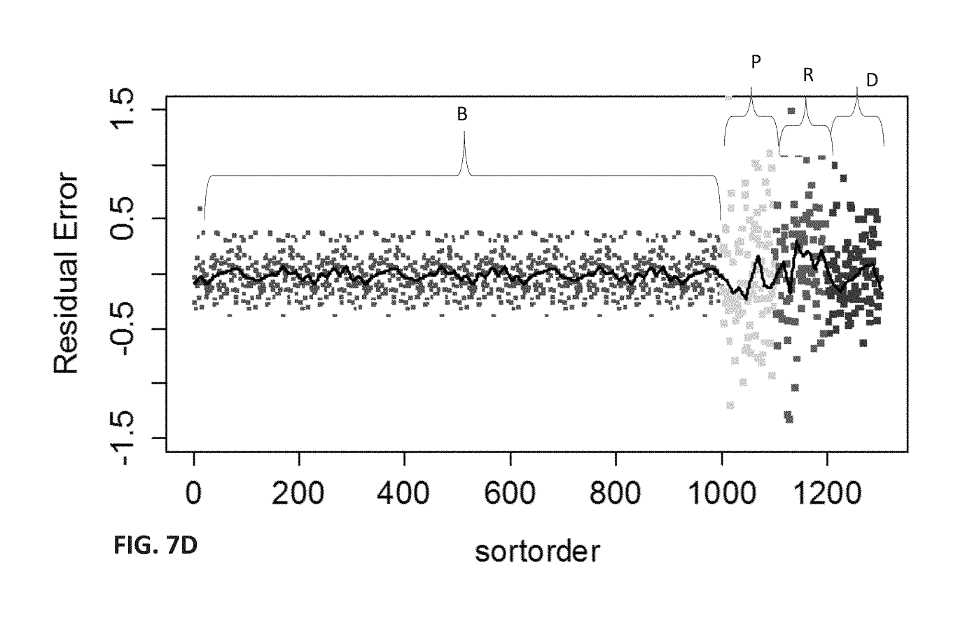

FIG. 6 illustrates an overview flowchart for process 600 for the diagnostic engine of the system in accordance with at least one of the various embodiments. FIGS. 7A-7D are graphs visually illustrating the operations of the system, including the diagnostic engine, as it analyzes and permutes entity behavior event (y) and predictor (x) data.

An exemplary operation of the diagnostic engine is described with respect to FIG. 6 and FIGS. 7A-7D below.

After a start block, at block 601, in at least one of the various embodiments, at block 602, the diagnostic engine receives an input of model predictors (x) and model errors ε for a set of entity events (y). The prediction classifier model output can include data processed by a statistical model, wherein the model errors are the difference between logged events (y) for entities and expected values ŷ, ε=(y−ŷ). For example, the model can be employed to predict latency of payment for a population of actors (y) from a collection of predictors (x), called the predicted latencies ŷ. The model errors are the collection of differences between behavior events—the observed behavior—and the model: ε=(y−ŷ).

FIGS. 7A-7B illustrates an example of a representative graph for a prediction model predictor (x) plotting a set of logged entity behavior events (y) generated by a statistical AI prediction classifier. The diagnostic engine can then begin with the output of the behavior events from a statistical machine learning model. FIG. 7A illustrates an example of a population of behavior events, whereby the distribution is such that a typical prediction model would not reveal a subgroup of irregular or malfeasant actors. The diagnostic engine employs the model errors ε, and the model predictors x, as argument rules. The diagnostic engine is then configured to optimize the machine generated prediction statistics for non-homoscedasticity via permutations of the data to discover and classify pockets of non-homoscedastic behavior as described below.

At block 603, in at least one of the various embodiments, the diagnostic engine is configured to initialize a permutation of the model predictors configured to derandomize and identify separate groups within the model that are obscured by the machine generated statistical prediction model and analysis. The initial value of this statistic, is 0 (e.g. d_1(0) . . . d_m(0)). At value 0, with no initial permutation, the initial grouping of the event data does not yield any segregateable pockets of behavior. A visual graph plotting the events on the horizontal predictor (x) is illustrated in the plotted data shown in FIG. 7C, which illustrates the statistic for non-homoscedasticity as the difference between a horizontal line and a smooth curve on the plot of error in predicted behavior vs. a particular predictor (x), which at 0 is no difference (i.e. a straight horizontal line).

As will be appreciated, FIGS. 7B-7C illustrate examples of the population of entity behavior events prior to identification and grouping by the diagnostic engine, but with the irregular visually behavior identified for the purpose of illustrating that the subgroup cannot be distinguished absent the diagnostic tools as described herein. That is to say, if the ‘bad’ actors were not identified in the illustrated graphs, they would be indistinguishable from the population. Moreover, the overall model diagnostic—in the example a smoothed curve fit to the predictor vs. the error—would also look accurate absent processing by the diagnostic engine, as now described below.

At block 604, in at least one of the various embodiments, the diagnostic engine is configured to iterate a permutation of the model predictors x; the iteration comprising taking the initial diagnostic statistical value (d m(0)) for each event as initialized at block 603 and independently permuting the event data (m) with respect to that diagnostic value. The permutation search for each mth diagnostic is independent, out of M possible, wherein the diagnostic is a smooth curve fitted to the square root of model errors squared as shown above. The diagnostic engine proceeds by running optimization operations in parallel for each entity behavior event diagnostic d_1 . . . D_m to optimize a collection of entity behavior events for a statistical analysis for heteroscedasticity. The diagnostic engine takes an initial value of each statistic—diagnostic d_1(0) . . . d_m(0)—and independently permutes each entity behavior event statistic with respect to that diagnostic.

At block 605, in at least one of the various embodiments, the diagnostic engine is configured to run the permutations. In embodiments, the permutations can be completely random, ordered and exhaustive—for example where each next permutation is a small partial reordering of the last, or otherwise. In this example a particular predictor x is chosen—say past latency of payment—and the diagnostic is non-horizontal-ness of a curve fit (i.e., non 0 value) from latency of payment (event—y) to the model error.

At block 606, in at least one of the various embodiments, the diagnostic engine then iterates the diagnostic operations including the permuted model predictors to identify irregular events (pockets) in the set of events, and the diagnostic operations comprise a permutation that minimizes the smoothness of the curve, thereby maximizing the distance from the initial model prediction vector for each diagnostic permutation of the behavior event. The diagnostic engine proceeds with each new permutation as long as the diagnostic can be further improved.

For example, at blocks 611-1, 611-m, in at least one of the various embodiments, the diagnostic value i for each event y is permuted in parallel by the diagnostic d_1(i+1) . . . d_m(i=1) for the permutation of the model prediction x(j)→x(j+1). At decision block 612-1, 612-m the diagnostic engine determines if the permuted diagnostic value for d_1(i+1) . . . d_m(i=1) is greater than distance d(i). If not (N), at decision block 613-1, 613-m the diagnostic engine determines that j+1=i and reiterates the permuted diagnostic value, repeating the process again at starting block 604 with the newly permuted diagnostic value. If, however, at decision block 612-1,612-m the diagnostic engine determines if the permuted diagnostic value for d_1(i+1) . . . d_m(i=1) is greater than distance d(i) (Y), at decision block 614-1, 614-m the diagnostic engine determines if d=i. If so (Y), the diagnostic engine determines that j=i and reiterates the permuted diagnostic value, repeating the process again at block 604-1, 604-m. If not (N), the diagnostic engine determines no more permutations will improve the model diagnostic, and at block 607 the diagnostic engine ends the permutations and prepares the permuted data for each event (y) and predictor (x) plot for d_1(t_1), x(t_m); . . . d_m(t_m), x(t_m) for output.

In this exemplary flow above, the data are reordered until the smooth curve is maximized, that is, as far from horizontal as possible. The data ordering at the block 607 yields a classification grouping for heteroscedastic behavior with respect to each diagnostic. FIG. 7D illustrates a graph replotting and sorting the diagnostic engine's permutations of each event. sorting and classifying groups of events for each diagnostic. As shown in the graph, the smoothed curve deviates from horizontal such that as the curve differentiates, the plotted entity behavior events (y) differentiate and spread out proportional to the curve, and those that do so in a consistent way will group together along in accord with each permuted diagnostic value 1 . . . m to the curve fit. As FIG. 7D illustrates, group boundaries between the event populations are clear from the behavior event distribution along permuted diagnostic line after processing by the diagnostic engine. The groups B,P,R,D of behavior can now be logged and annotated for classification.

The discovered and annotated groups as well as the original output are now inputs for further or secondary modeling by an optimized classifier builder. As shown in FIG. 7D there are 4 groups B,P,R,D of events that differentiate in accord with the movement of the curve. Three sub-groups P,R,D of events are separated out the behavior events that were obscured by the original distribution of events from the original prediction classifier model building component, previously appearing to be random outliers with respect to the prediction classification. In the example, the diagnostic engine discovered and differentiated three groups P,R,D that can be modeled separately out of the original population from the initial model, for example, three new separate statistical models for predicted payment latency. The secondary models can now provide better fits and better predictions as dissimilar behavior events from dissimilar entities are now separated out.

Thus at block 607, in at least one of the various embodiments, the diagnostic engine can output set of events including the identification and derandomization of the irregular events, and the groupings of the derandomized behavior events, including categorization of the events to an optimized classifier builder. The optimized classifier can then build optimized predictor rules for classifying derandomized relationship events and outputting a predictive classifier model for training and production.

At operation 407 is output from the diagnosis engine to an optimized prediction classifier model building component 408 including at least one predictor module for classifying derandomized relationship events including the newly identified groupings and outputting an optimized predictive classifier model. At operation 409 the optimized predictive classifier model can then be output to prediction engine 410 to include one or more recalibrated classifiers configured to produce automated entity behavior predictions including classifications of derandomized entity behaviors. In an embodiment, as more behavior events are logged, the system can be configured to update the entity database repository 402 to include the derandomized relationship events.

The system including the diagnostic engine can thereby perform optimized AI machine learning classification of entity event behavior and prediction—including adaptation and updating—and model checking diagnostics which require AI machine learning implementation due to the size and scale of the event analysis.

In at least one of the various embodiments, entity behavior event information and classification may be stored in one or more data stores as described with respect to FIG. 1, for later processing and/or analysis. Likewise, in at least one of the various embodiments, entity behavior event information and classification may be processed as it is determined or received.

FIGS. 4 and 6 thus describe embodiments whereby the bias and prediction error are reduced as the models have been recalibrated by a diagnostic engine that configured to identify heterogeneous pockets of event behavior (e.g., to make accurate predictions of payment latency). FIG. 3, in contrast illustrates, a prediction classifier model builder that makes non-optimal predictions as the models tuned to data that hide suspicious behavior. FIG. 3 illustrates and an architecture and process flow without the diagnostic engine and optimized classifier model building as described herein. In the ordinary setup, models are fit without in process identification of malfeasant actors or relationship. These data then generate estimates for non-malfeasant groups and are included in model predictions. In the example the system is configured to analyze a heterogeneous population of normal and fraudulent actors—measured on covariates in a model where latency of payment is the response. The malfeasant actors, however, are sophisticated enough with respect to the model (the predictive covariates or other correlative and the response/prediction)—to conceal their behavior. At block 304 the model estimates for all actors—and thus predictions—are biased by data that includes malfeasant behavior. Malfeasant actors, in benefit of anonymity with respect to the model, remain unidentified and receive ordinary model predictions for the event behavior, e.g., for lateness of payment. Thus, the in system architecture and operations illustrated in FIG. 3, the model outputs are biased by an estimation error, and abnormal actors and the predictions are also inaccurate.

As will again be appreciated, though examples as described herein use statistical regression models, classifier models and model prediction as used herein broadly includes methods and modeling for correlation, covariance, association, pattern recognition, clustering, and grouping for heteroscedastic analysis as described herein, including methods such as neuromorphic models (e.g. for neuromorphic computing and engineering) and other non-regressive models or methods.

### Example—Business Malfeasance

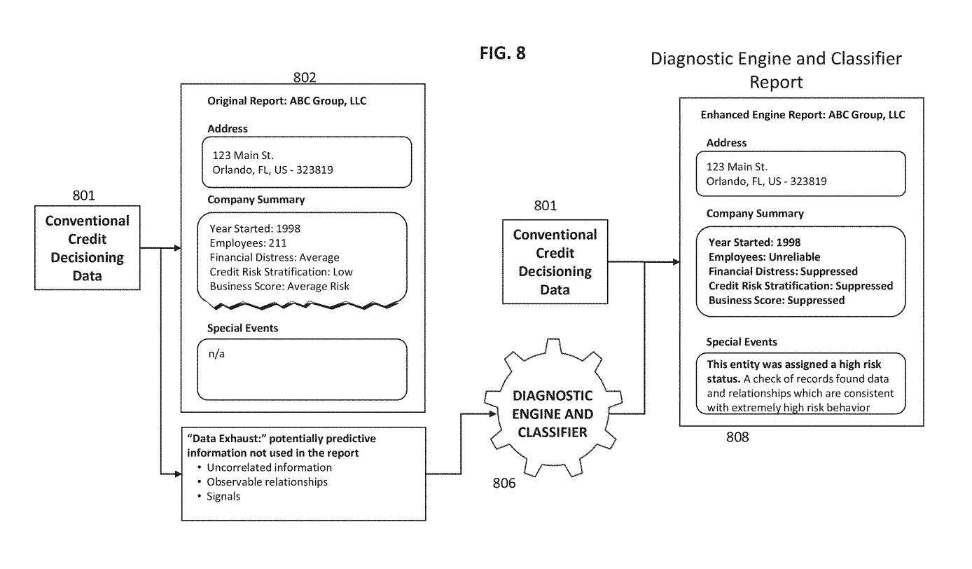

In an exemplary embodiment, an optimized prediction engine can be configured to automated entity behavior predictions including classifications of derandomized behaviors. For example, a business entity analytics platform can produce entity ratings based on entity behavior events. The business entity analytics platform can provide, for instance, a business credit report, comprising ratings (e.g., grades, scores, comparative/superlative descriptors, firmographic data) based on one or more predictor models using conventional analysis of event data 801 and generating the report using data logged as relevant to credit reporting. An exemplary conventional report 802 is shown, for example, in FIG. 8. One or more of the classifications from the predictor models, however, can mask malfeasant business activity that benefits from the ratings and report. For example, an identity thief operating in accord with a scam may steal the identity of a business entity by engaging in transactions or activities that are legitimate on their face and conducted in the ordinary course of that business, which are logged as behavior events for an analysis by a predictor rule, but are unidentified and unclassified by the conventional analysis. Accordingly, the scam may proceed in accord with legitimate activities that have a pattern which is masked and appears random when processed by the conventional predictor rule, but are identified as an irregular grouping of derandomized events.

In an embodiment, the diagnostic engine and classifier 806 is configured to separate and label the irregular groupings from the derandomized events into a risk behavior classification for the business entity rating for the diagnostic database or data package as described herein. This new data is used to generate an optimized predictive classifier model. The diagnostic engine can be configured to output the diagnostic database or data package including the risk classification to the optimized classifier model building component; which can generate or include one or more risk predictor rules generated from the diagnostic database. The optimized prediction engine can be configured to include the classifier, which is used produce automated entity behavior predictions including risk classifications for the derandomized behaviors.

For example, in an embodiment, the optimized prediction engine including the risk classifications for a credit report can identify and classify a business entity pattern that conforms to an irregular grouping indicating an identity thief is controlling the business entity. In the embodiment, the report interface generates a warning report 808 nullifies the credit report and flags the business entity as high risk or with an identity theft warning. In another embodiment, the system may except the business entity from and further ratings or analysis. In another embodiment, the business can be flagged for follow up investigation.

### Example—Adjacent Classification

In an exemplary embodiment, an optimized prediction engine can be configured to automate entity behavior predictions including classifications of derandomized behaviors that are unexplained. For example, the behavior analytics platform can produce and entity classification based on entity behavior events. The behavior analytics platform can provide, for instance, a marketing classification for a marketing platform or Customer Relationship Management (CRM) platform based on one or more predictor models that identify demographic targets for marketing channels. One or more of the classifications, however, can mask unexplained activity. For example, persons identified as a millennial may be interacting and generating engagements (e.g., “likes” or other positive/negative/neutral engagements graded as approval or disapproval) with target products on social media platforms on a regular basis, which are logged as behavior events for an analysis by a predictor rule. However, certain engagements have a pattern which is masked by the classification by the conventional predictor rule, but are identified as an irregular grouping of derandomized events, for example, millennial users that automate or outsource their social media engagements for business marketing. In an embodiment, the diagnostic engine is configured to separate and label the irregular groupings from the derandomized events into an adjacent classification for the business entity rating for the diagnostic database or data package. This new data is used to generate an optimized predictive classifier model. The diagnostic engine can be configured to output the diagnostic database or data package including the adjacent classification to the optimized classifier model building component; which can generate or include one or more adjacent predictor rules generated from the diagnostic database. The optimized prediction engine can be configured to include the classifier, which is used produce automated entity behavior predictions including adjacent classifications for the derandomized behaviors.

For example, in an embodiment, the optimized prediction engine including the adjacent classifications for a marketing channel report can identify engagements that conform to an irregular grouping indicating that a user is millennial business operator who has outsourced or automated their social media engagements. In the embodiment, the report interface updates the report and flags the engagements associated with the irregular pattern as belonging to social media marketing services.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system or even a group of multiple computer systems. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

1. A system for building behavior prediction classifiers for a machine learning application comprising:
a memory for storing at least instructions;
a processor device that is operative to execute program instructions;
a database of entity behavior events;
a prediction classifier model building component comprising a predictor rule for analyzing each of a plurality inputted set of behavior events from the database of entity events and outputting a prediction classifier and a classification of each of the set of events, wherein an error for the prediction classifier is defined as random over the classification;
a diagnostic engine comprising:
an input configured to receive a permutation of the error for the at least one prediction rule and the set of classified events;
a diagnostic module configured to:
derandomize the prediction classifier; and
separate and label the irregular groupings from the derandomized events to form a diagnostic database or data package, and
output the diagnostic database or data package to an optimized classifier building component;
an optimized classifier builder component comprising one or more predictor rules for classifying derandomized relationship events and outputting an optimized predictive classifier; and
a prediction engine including a classifier configured to produce automated entity behavior predictions including classifications of derandomized behaviors.

2. The system of claim 1 wherein the diagnostic engine module is configured to derandomize the prediction classifier by at least:
applying the permutation of the error to each of the classified set of events,
calculating the smoothness of the permuted set of events, and
applying a maximizer to the smoothed events to reveal irregular groupings of events in the smoothed data; and
separate and label the irregular groupings from the smoothed events to form the diagnostic database or data package.

3. The system of claim 2 wherein the diagnostic engine module is configured to derandomize the prediction classifier by at least: calculating and smoothing each of the events in parallel.

4. The system of claim 3 wherein the diagnostic engine module is configured to derandomize a region of interest with the prediction classifier.

5. The system of claim 1 wherein the permutation is associated with the error for at least one prediction rule configured to define an overdispersion of the classified set of events.

6. The system of claim 1 wherein the system further comprises:
the database of entity behavior events comprising events analyzed to provide a business entity rating classification; and
the predictor rule comprising a predictor for a business entity rating classification that can mask malfeasant business activity that benefits from the rating.

7. The system of claim 6 wherein the system further comprises:
the diagnostic engine being configured to separate and label the irregular groupings from the derandomized events into a risk behavior classification for the business entity rating for the diagnostic database or data package.

8. The system of claim 7 wherein the system further comprises:
the diagnostic engine being configured to output the diagnostic database or data package including the risk classification to the optimized classifier building component;
the optimized classifier builder component comprising one or more risk predictor rules generated from the diagnostic database; and
the prediction engine including the classifier configured to produce automated entity behavior predictions including risk classifications for the derandomized behaviors.

9. The system of claim 1 wherein the system further comprises:
the database of entity behavior events comprising events analyzed to classify behavior events; and
the predictor rule comprising a predictor for an entity classification that can mask unknown activity unexplained by the classification.

10. The system of claim 9 wherein the system further comprises:
the diagnostic engine being configured to separate and label the irregular groupings from the derandomized events into a classification adjacent behavior for the diagnostic database or data package.

11. The system of claim 10 wherein the system further comprises:
the diagnostic engine being configured to output the diagnostic database or data package including the adjacent classification to the optimized classifier building component;
the optimized classifier builder component comprising one or more classification adjacent predictor rules generated from the diagnostic database; and
the prediction engine including the classifier configured to produce automated entity behavior predictions including classification-adjacent classifications for the derandomized behaviors.

12. The system of claim 1, wherein the system comprises a network computer.

13. A computer implemented method for a computer comprising a memory for storing at least instructions and a processor device that is operative to execute program instructions; the method comprising:
providing a database of entity behavior events;
analyzing each of a plurality inputted set of behavior events from the database of entity events with a predictor rule;
outputting a prediction classifier and a classification of each of the set of events to a diagnostic engine, wherein an error for the prediction classifier is defined as random over the classification;
derandomize the prediction classifier using the diagnostic engine;
separate and label the irregular groupings from the derandomized events to form a diagnostic database or data package.

14. The method of claim 13, wherein the method further comprises:
outputting the diagnostic database or data package to an optimized classifier building component; and
classifying derandomized relationship events with the optimized classifier builder component comprising one or more of the predictor rules; and
outputting an optimized predictive classifier to a prediction engine.

15. The method of claim 13, wherein the method further comprises:
producing automated entity behavior predictions including classifications of derandomized behaviors with the prediction engine

16. The method of claim 13 wherein the diagnostic engine module is configured to derandomize the prediction classifier by at least:
applying a permutation of the error to each of the classified set of events,
calculating the smoothness of the permuted set of events, and
applying a maximizer to the smoothed events to reveal irregular groupings of events in the smoothed data; and
separate and label the irregular groupings from the smoothed events to form the diagnostic database or data package.

17. The method of claim 16 wherein the diagnostic engine module is configured to derandomize the prediction classifier by at least: calculating and smoothing each of the events in parallel.

18. The method of claim 16 wherein the permutation is associated with the error for at least one prediction rule configured to define an overdispersion of the classified set of events.

19. The method of claim 13 wherein the method further comprises:
providing the database of entity behavior events comprising events analyzed to provide a business entity classification rating;
wherein the predictor rule comprises a predictor for a business entity rating that can mask malfeasant business activity that benefits from the classification rating.

20. The method of claim 19 wherein the method further comprises:
separating and labelling the irregular groupings from the derandomized events into a risk behavior classification for the business entity classification rating for the diagnostic database or data package.

21. The method of claim 20 wherein the method further comprises:
outputting the diagnostic database or data package including the risk classification to an optimized classifier building component;
the optimized classifier builder component comprising one or more risk predictor rules generated from the diagnostic database; and
the prediction engine including the classifier configured to produce automated entity behavior predictions including risk classifications for the derandomized behaviors.

22. The method of claim 13 wherein the method further comprises:
providing the database of entity behavior events comprising events analyzed to provide an entity classification; and
wherein the predictor rule comprising a predictor for a business entity rating that can mask unknown activity unexplained by the classification.

23. The method of claim 22 wherein the method further comprises:
the diagnostic engine being configured to separate and label the irregular groupings from the derandomized events into an adjacent classification for the business entity rating for the diagnostic database or data package.

24. The method of claim 23 wherein the method further comprises:
outputting the diagnostic database or data package including the adjacent classification to an optimized classifier building component;
the optimized classifier builder component comprising one or more adjacent predictor rules generated from the diagnostic database; and
the prediction engine including the classifier configured to produce automated entity behavior predictions including adjacent classifications for the derandomized behaviors.

25. A system comprising:
a memory for storing at least instructions;
a processor device that is operative to execute program instructions;
a database of entity behavior events;
a prediction classifier building component comprising a predictor rule for analyzing each of a plurality inputted set of behavior events from the database of entity events and outputting a prediction classifier and a classification of each of the set of events, wherein an error for the prediction classifier is defined as random over the classification;
a diagnostic engine comprising:
an input configured to receive a permutation of the error for the at least one prediction rule and the set of classified events;
a diagnostic module configured to:
derandomize the prediction classifier; and
separate and label the irregular groupings from the derandomized events to form a diagnostic database or data package.
